(19) United States
(12) Patent Application Publication
(10) Pub. No.: US 2013/0084844 A1
(43) Pub. Date: Apr. 4, 2013

(54) MOBILE COMMUNICATION DEVICE AND WIRELESS COMMUNICATION METHOD

(71) Applicant: FUJITSU MOBILE COMMUNICATIONS LIMITED, Kawasaki-shi (JP)

(72) Inventor: Naritoshi SAITO, Hino (JP)

(73) Assignee: FUJITSU MOBILE COMMUNICATIONS LIMITED, Kawasaki-shi (JP)

(21) Appl. No.: 13/625,651

(22) Filed: Sep. 24, 2012

(30) Foreign Application Priority Data
Sep. 30, 2011 (JP) 2011-215796

(51) Int. Cl. H04W 88/06

(52) U.S. Cl. 455/418

(57) ABSTRACT

A mobile communication device is capable of communication by utilizing first and second wireless access networks and has a storage unit, a wireless device, and a processor. The wireless device detects a wireless state of the first wireless access network and writes flag information in accordance with the detected wireless state to the storage unit. When a suspend state is cancelled, the processor controls connection with the second wireless access network based on the flag information stored in the storage unit.

### CROSS-REFERENCE TO RELATED APPLICATION

This application is based upon and claims the benefit of priority of the prior Japanese Patent Application No. 2011-215796, filed on Sep. 30, 2011, the entire contents of which are incorporated herein by reference.

### FIELD

The embodiments discussed herein relate to a mobile communication device and a wireless communication method.

### BACKGROUND

At present, a mobile communication system is utilized, in which a mobile communication device, such as a portable telephone unit and a portable information terminal device, performs communication by utilizing a wireless access network. A wireless access network includes one or more base stations accessible from a mobile communication device. As a wireless access network, there exists a plurality of kinds of wireless access network with different communication schemes, such as a CDMA (Code Division Multiple Access) 2000 1× network, EVDO (Evolution Data Only) network, WiMAX network, and wireless LAN (Local Area Network).

The 1× network and EVDO network use CDMA as the multiple access scheme. The WiMAX network and part of wireless LAN use OFDMA (Orthogonal Frequency Division Multiple Access) as the multiple access scheme. Some mobile communication devices are capable of utilizing a plurality of kinds of wireless access network by mounting a plurality of wireless devices.

Note that, there is proposed a wireless terminal device, which is a terminal capable of utilizing a wide wireless network and a narrow wireless network, configured to start processing to connect to a wide wireless network when detecting that signal quality deteriorates below a reference value while utilizing a narrow wireless network. Further, there is proposed a portable terminal, which is a terminal capable of utilizing a wireless LAN and a mobile communication network, configured to start data communication that utilizes a mobile communication network by notifying a user that he or she is out of the range and waiting for a response of acknowledgment from the user when detecting that the user has moved out of the range of the wireless LAN. For example, the following literature describes such devices and terminals:
Japanese Laid-Open Patent Publication No. 2008-118721
Japanese Laid-Open Patent Publication No. 2010-161657

As described above, it is conceived that a mobile communication device controls connection to another wireless access network in accordance with the wireless state (for example, whether being in the range or out of the range) of a wireless access network. For example, it is conceived that when a mobile communication device connects to a wireless access network and detects that the mobile communication device has moved out of the range of the wireless access network, the mobile communication device establishes a connection with another wireless access network.

Incidentally, a mobile communication device sometimes uses a processor, such as a CPU (Central Processing Unit), for communication control. In some cases, the processor makes transition to a suspend state of low power consumption if an event, such as data communication, does not occur for a fixed period of time. For example, in the suspend state, the processor stops execution of application programs and driver programs and waits for an event and returns to the active state when detecting an event by an interrupt signal etc. However, even when the processor is in the suspend state, it is possible for a wireless device to continue signal processing, such as wireless synchronization, in accordance with an instruction from the processor before entering the suspend state.

When a processor is used for communication control, the wireless state of a wireless access network may be detected by a wireless device even during suspend and on the other hand, control of a connection with another wireless access network is performed by the processor having returned to the active state from the suspend state. Here, there arises such a problem that how the processor having returned to the active state recognizes the wireless state of a wireless access network when performing connection control.

As one method, there may be conceived a method that utilizes an interrupt signal from a wireless device to a processor. For example, when receiving an interrupt signal from a wireless device during standby, it is conceived that the processor interprets that the wireless state of a wireless access network has changed. However, this method has such a problem that the reliability of an interrupt signal as transmitting means is not high. For example, there is a possibility that the processor fails to receive an interrupt signal at some timings and it is difficult to recognize the most recent wireless state when the wireless state has changed a plurality of times during a brief period of time. Consequently, it is difficult to accurately recognize the wireless state only by an interrupt signal.

As another method, there may be conceived a method for confirming the current wireless state of a wireless access network by the processor having returned to the active state transmitting a command to a wireless device. By this method, it is possible for the processor to obtain more reliable information than that obtained by the method for estimating the wireless state from an interrupt signal. However, this method has such a problem that the overhead of waiting for a response to a command of the processor is large, and therefore, the delay in connection control becomes significant.

### SUMMARY

According to an aspect, there is provided a mobile communication device capable of communication by utilizing first and second wireless access networks, including a storage unit, a wireless device configured to detect a wireless state of the first wireless access network and to write flag information in accordance with the detected wireless state to the storage unit, and a processor configured to control connection with the second wireless access network based on the flag information stored in the storage unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a mobile communication device of a first embodiment;

FIG. 2 illustrates a mobile communication system of a second embodiment;

FIG. 3 illustrates an example of an area of a wireless access network;

FIG. 4 illustrates an example of a reception timing of paging;

FIG. 5 is a block diagram illustrating a hardware example of a mobile station;

FIG. 6 is a block diagram illustrating an interface of the second embodiment;

FIG. 7 illustrates combinations of out-of-range flags;

FIG. 8 is a block diagram illustrating an example of software configured to control a mobile station;

FIG. 9 illustrates an example of transition of a data communication state;

FIG. 10 illustrates an example of hierarchy of a data communication protocol;

FIG. 11 is a flowchart illustrating standby processing by a wireless device;

FIG. 12 is a flowchart illustrating connection control of the second embodiment;

FIG. 13 is a flowchart illustrating out-of-range processing by a wireless device;

FIG. 14 is a sequence diagram illustrating an example of connection to a wireless access network;

FIG. 15 is a sequence diagram illustrating an example of PPP connection;

FIG. 16 is a sequence diagram illustrating an example of reception of a paging channel;

FIG. 17 is a block diagram illustrating an interface of a third embodiment; and

FIG. 18 is a flowchart illustrating connection control of the third embodiment.

### DESCRIPTION OF EMBODIMENTS

Several embodiments will be described below with reference to the accompanying drawings, wherein like reference numerals refer to like elements throughout.

### First Embodiment

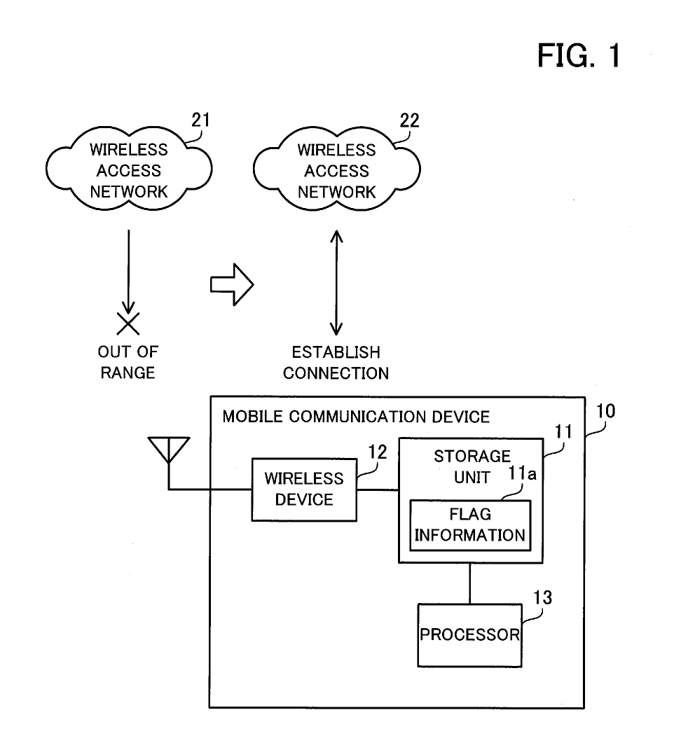

FIG. 1 illustrates a mobile communication device of a first embodiment.

A mobile communication device 10 is a wireless terminal device, such as a portable telephone unit and a portable information terminal device. The mobile communication device 10 is capable of performing communication by utilizing wireless access networks 21 and 22 and may be capable of utilizing three or more wireless access networks. When it is possible for the mobile communication device 10 to perform data communication (for example, packet communication) by utilizing a plurality of wireless access networks including the wireless access networks 21 and 22, it may be said that the mobile communication device 10 is capable of operating in a multimode as to data communication. Data communication is performed by selecting, for example, any one of wireless access networks.

The wireless access networks 21 and 22 include one or more base stations accessible from the mobile communication device 10. The wireless access networks 21 and 22 may have wireless communication schemes different from each other. For example, the wireless access network 21 may be a wireless access network using OFDMA, such as a WiMAX network, LTE (Long Term Evolution) network, LTE-A (Long Term Evolution Advanced), and wireless LAN. In addition, the wireless access network 22 may be a wireless access network using CDMA, such as an EVDO network and W-CDMA (Wideband Code Division Multiple Access) network. The wireless access networks 21 and 22 may have sizes of coverage area different from each other. For example, the wireless access network 21 may have an area smaller than that of the wireless access network 22.

The mobile communication device 10 has a storage unit 11, a wireless device 12, and a processor 13.

The storage unit 11 is accessible from the wireless device 12 and the processor 13 and includes a storage region at least writable from the wireless device 12 and readable from the processor 13. The storage unit 11 may be a volatile memory, such as a RAM (Random Access Memory), register, and cache memory, or a nonvolatile memory, such as a flash memory.

The wireless device 12 processes a signal received from the wireless access network 21. It is possible for the wireless device 12 to continue processing of the received signal in accordance with an instruction from the processor 13 before entering the suspend state even while the processor 13 is in the suspend state. The wireless device 12 detects the wireless state of the wireless access network 21. For example, the wireless device 12 detects whether being in the range or out of the range of the wireless access network 21 based on a received power level. Then, the wireless device 12 writes flag information 11a in accordance with the wireless state to the storage unit 11. For example, it is possible to allocate one bit to the flag information 11a, indicating being in the range or out of the range (for example, it is assumed that being in the range=0 and being out of the range=1).

It is to be noted that, there is a case where the wireless device 12 receives a paging channel intermittently during standby after data communication by utilizing the wireless access network 21. For example, the wireless device 12 determines whether being in the range or out of the range of the wireless access network 21 at a timing to receive a paging channel. In the paging channel, call information (paging information) of the mobile communication device 10 may be transferred. After the data communication by utilizing the wireless access network 21, the data communication path is set in the wireless access network 21, and therefore, paging information is transmitted from the wireless access network 21. On the other hand, when connection with the wireless access network 22 is established, the data communication path is set in the wireless access network 22, and paging information begins to be transmitted from the wireless access network 22.

The processor 13 is an arithmetic device configured to control the connection with the wireless access networks 21 and 22. The processor 13 may be a CPU configured to execute programs or a DSP (Digital Signal Processor). Programs are stored in the storage unit 11 or in another storage unit. The processor 13 makes transition to the suspend state of low power consumption if an event, such as data communication, does not occur for a fixed period of time. For example, the processor 13 stops execution of application programs and driver programs in the suspend state and waits for an event and when detecting an event by an interrupt signal etc., the processor 13 returns to the active state. An interrupt signal is transmitted from the wireless device 12 when, for example, being out of the range of the wireless access network 21 is detected.

When the suspend state is cancelled, the processor 13 accesses the flag information 11a stored in the storage unit 11 and controls the connection with the wireless access network 22 based on the flag information 11a. For example, the processor 13 determines whether the flag information 11a indicates being out of the range and selects whether or not to establish connection with the wireless access network 22 in accordance with the determination result. It may also be possible to design so that the processor 13 establishes connection with the wireless access network 22 when the flag information 11a indicates being out of the range and does not establish connection with the wireless access network 22 in other cases.

The connection to be established may be PPP (Point-to-Point Protocol) connection. When the connection with the wireless access network 22 is established, for example, the data communication path switches from the wireless access network 21 to the wireless access network 22 and the mobile communication device 10 is enabled to receive paging information relating to data communication from the wireless access network 22. It may also be possible for the processor 13 to make transition again to the suspend state after performing connection control based on the flag information 11a.

Note that, as described previously, the mobile communication device 10 may be capable of further utilizing another wireless access network other than the wireless access networks 21 and 22. It may also be possible for the mobile communication device 10 to further include another wireless device configured to process a received signal from another wireless access network. For example, the other wireless device detects the wireless state of the other wireless access network and writes another piece of flag information (for example, one bit indicating being in the range or out of the range) in accordance with the detected wireless state to the storage unit 11.

In that case, it may also be possible for the processor 13 to control the connection with the wireless access network 22 based on the combination of the flag information 11a and another piece of flag information. For example, the processor 13 determines whether both the flag information 11a and the other piece of flag information indicate being out of the range and selects whether or not to establish connection with the wireless access network 22 in accordance with the determination result. It may also be possible to design so that the processor 13 establishes connection with the wireless access network 22 when both the flag information 11a and the other piece of flag information indicate being out of the range and does not establish the connection with the wireless access network 22 in other cases.

According to the mobile communication device 10 of the first embodiment, the flag information 11a in accordance with the wireless state of the wireless access network 21 is written to the storage unit 11. When the suspend state of the processor 13 is cancelled, the processor 13 accesses the flag information 11a stored in the storage unit 11. Based on the flag information 11a, the connection with the wireless access network 22 is controlled.

By writing the flag information 11a to the storage unit 11, it is made possible for the processor 13 whose suspend state is cancelled to recognize the wireless state more precisely than when estimating the wireless state of the wireless access network 21 based on the interrupt signal. Consequently, it is possible to suppress an error of connection control, such as that connection is established erroneously when it is not necessary to establish connection with the wireless access network 22. Further, after the suspend state is cancelled, it is not necessary for the processor 13 to inquire the wireless state of the wireless access network 21 by transmitting a command to the wireless device 12. Consequently, it is possible to quickly check the wireless state and to reduce the overhead of connection control.

Because of this, for example, even if the mobile communication device 10 moves out of the range of the wireless access network 21 during standby, it is possible to quickly switch the data communication path to the wireless access network 22 and to reduce the period of time during which reception of the paging channel relating to data communication is not available. Further, it is possible to reduce the period of time during which the processor 13 is in the active state during standby and to reduce power consumption.

Further, when it is possible for the mobile communication device 10 to utilize two or more wireless access networks (including the wireless access network 21) other than the wireless access network 22, it is also possible to store two or more pieces of flag information corresponding to two or more wireless access networks in the storage unit 11. In this case, it is made easy for the processor 13 to check the combination of the wireless states of the two or more wireless access networks and it is made possible to quickly perform connection control of the wireless access network 22.

In a second embodiment to be explained below, an example is taken, in which the mobile station performs data communication using the EVDO network, the WiMAX network, and the wireless LAN. It may also be possible, however, to apply a communication control method to be explained in the second embodiment to other kinds of wireless access network, such as a W-CDMA network, LTE network, and LTE-A network.

### Second Embodiment

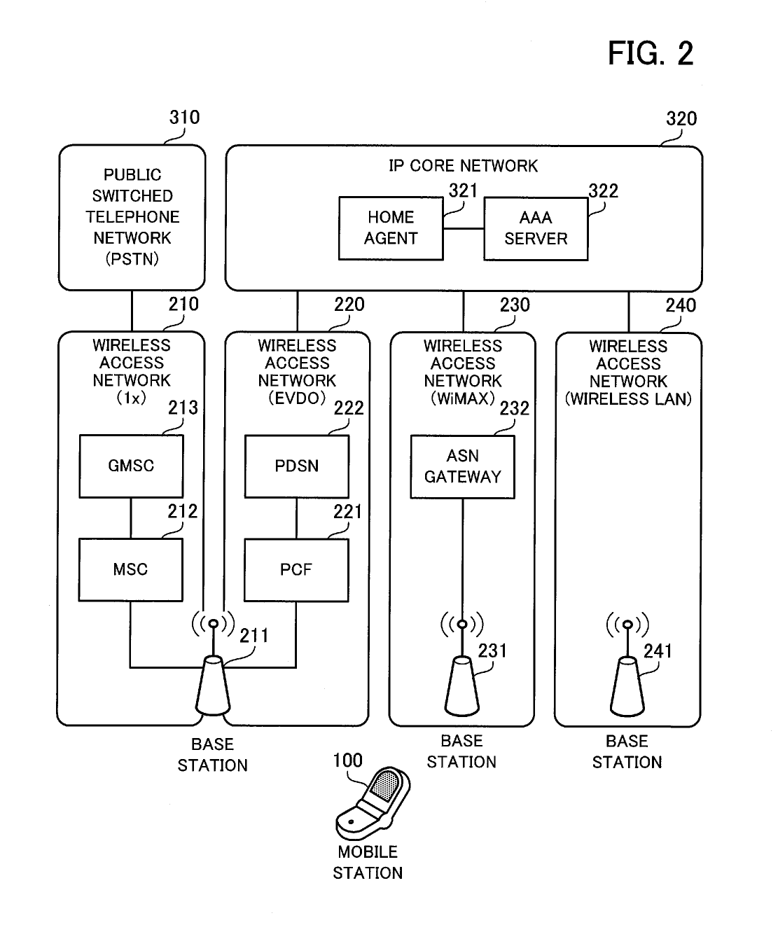

FIG. 2 illustrates a mobile communication system of the second embodiment. The mobile communication system of the second embodiment has a mobile station 100, wireless access networks 210, 220, 230, and 240, a public switched telephone network (PSTN) 310, and an IP (Internet Protocol) core network 320.

The mobile station 100 is a wireless terminal device, such as a portable telephone unit and portable information terminal device. It is possible for the mobile station 100 to utilize four communication schemes, that is, CDMA 2000 1×, CDMA 2000 EVDO, WiMAX, and wireless LAN. The mobile station 100 performs audio communication by the 1× scheme and performs data communication by the EVDO scheme, the WiMAX scheme, and the wireless LAN scheme.

The wireless access network 210 is network that performs wireless communication with the mobile station 100 by the CDMA 2000 1× scheme and transmits an audio signal by the circuit switching system. The wireless access network 210 is connected to the PSTN 310. The wireless access network 210 has a plurality of base stations including a base station 211, an MSC (Mobile Switching Center) 212, and a GMSC (Gateway Mobile Switching Center) 213. Each base station belonging to the wireless access network 210 forms a cell and the area of the wireless access network 210 is formed by a set of cells.

The base station 211 is a communication device that performs wireless communication with the mobile station 100 and performs wired communication with the MSC 212. The base station 211 transfers an audio signal between the mobile station 100 and the MSC 212. The MSC 212 is switching equipment connected to the base station 211 and the GMSC 213. The MSC 212 transfers an audio signal by referring to subscriber information database formed in an HLR (Home Location Register), not illustrated. The GMSC 213 is a gateway device connected to the PSTN 310 and transfers an audio signal.

The wireless access network 220 is a network that performs wireless communication with the mobile station 100 by the CDMA 2000 EVDO scheme and transfers data by the packet switching system. The wireless access network 220 is connected to the IP core network 320. The wireless access network 220 has a plurality of base stations used in common by the wireless access network 210, a PCF (Packet Control Function) 221, and a PDSN (Packet Data Serving Node) 222. Each base station forms a cell and the area of the wireless access network 220 is formed by a set of cells. Note that, in the example of FIG. 2, the base station 211 belongs to both of the wireless access networks 210 and 220, however, it may also be possible to divide the base stations into one for the wireless access network 210 and one for the wireless access network 220.

The base station 211 performs wireless communication with the mobile station 100 and performs wired communication with the PCF 221. The base station 211 transfers packet format data between the mobile station 100 and the PCF 221. The PCF 221 is connected to the base station 211 and the PDSN 222 and transfers packet format data. The PDSN 222 is a gateway device connected to the IP core network 320. The PDSN 222 establishes PPP connection with the mobile station 100 via the base station 211 and the PCF 221 and transfers packet format data.

The wireless access network 230 is a network that performs wireless communication with the mobile station 100 by the WiMAX scheme and transmits data by the packet switching system. The wireless access network 230 is connected to the IP core network 320. The wireless access network 230 has a plurality of base stations including a base station 231 and an ASN (Access Service Network) gateway 232. Each base station forms a cell and the area of the wireless access network 230 is formed by a set of cells.

The base station 231 is a communication device that performs wireless communication with the mobile station 100 and performs wired communication with the ASN gateway 232. The base station 231 transfers packet format data between the mobile station 100 and the ASN gateway 232. The ASN gateway 232 is a gateway device connected to the IP core network 320 and transfers packet format data.

The wireless access network 240 is a network that performs wireless communication with the mobile station 100 by the IEEE (Institute of Electrical and Electronics Engineers) 802.11 based wireless LAN scheme and transmits data by the packet switching system. The wireless access network 240 is connected to the IP core network 320. The wireless access network 240 has one or more base stations including a base station 241. Each base station is sometimes called an access point. Each base station forms a cell and the area of the wireless access network 240 is formed by a set of cells.

The base station 241 is a communication device that performs wireless communication with the mobile station 100 and performs wired communication with the IP core network 320. The base station 241 transfers packet format data between the mobile station 100 and the IP core network 320. Between the base station 241 and the IP core network 320, a relay may exist. It is to be noted that, a wireless device that conforms to the IEEE 802.11 based standard and is certified by the WiFi alliance is called a WiFi device.

The PSTN 310 is a telephone network that transmits an audio signal by the circuit switching system and includes switching equipment. The PSTN 310 may be utilized by a fixed telephone unit. Note that, it may also be possible to use ISDN (Integrated Service Digital Network) in place of the PSTN 310.

The IP core network 320 is an IP network that controls data communication of the mobile station 100 and transmits data by the packet switching system. The IP core network 320 is connected to the wireless access networks 220, 230, and 240. The IP core network 320 has a home agent (HA) 321 and an AAA (Authentication, Authorization and Accounting) server 322.

The home agent 321 is a communication device that registers the mobile station 100 utilizing the wireless access networks 220, 230, and 240 and transfers data of the mobile station 100 based on registered information. The home agent 321 checks whether the mobile station 100 performs data communication by utilizing any of the wireless access networks 220, 230, and 240 and selectively transfers data addressed to the mobile station 100 to the wireless access networks 220, 230, and 240. The AAA server 322 is a server device that performs authentication of the mobile station 100 and accounting to a user of the mobile station 100.

Here, the mobile station 100 selects any one of the wireless access networks 220, 230, and 240 and performs data communication. The data communication path is exclusively set in one of the wireless access networks 220, 230, and 240. When the mobile station 100 establishes PPP connection with the wireless access network 220, the mobile station 100 and the IP core network 320 recognize that the state is one where the data communication path is set in the wireless access network 220 and the wireless access networks 230 and 240 are not utilized. When the mobile station 100 connects to the wireless access network 230 or the wireless access network 240 (when the mobile station 100 performs the entry procedure), the mobile station 100 and the IP core network 320 recognize that the data communication path is switched to the wireless access network 230 or the wireless access network 240 and the PPP connection of the wireless access network 220 is disabled.

When the mobile station 100 is not performing data communication, if data to be transmitted from the IP core network 320 to the mobile station 100 occurs, from any one of the wireless access networks 220, 230, and 240, paging information is transmitted to the mobile station 100. When the PPP connection of the wireless access network 220 is established, the base station 211 transmits the paging information to the mobile station 100. When the mobile station 100 is connected to the wireless access network 230, the base station 231 transmits the paging information to the mobile station 100 and when the mobile station 100 is connected to the wireless access network 240, the base station 241 transmits the paging information to the mobile station 100.

Note that, the mobile station 100 is an example of the mobile communication device 10 of the first embodiment. The wireless access networks 230 and 240 are each an example of the wireless access network 21 of the first embodiment and the wireless access network 220 is an example of the wireless access network 22 of the first embodiment. Furthermore, in the following, explanation of audio communication by utilizing the wireless access network 210 may be omitted sometimes.

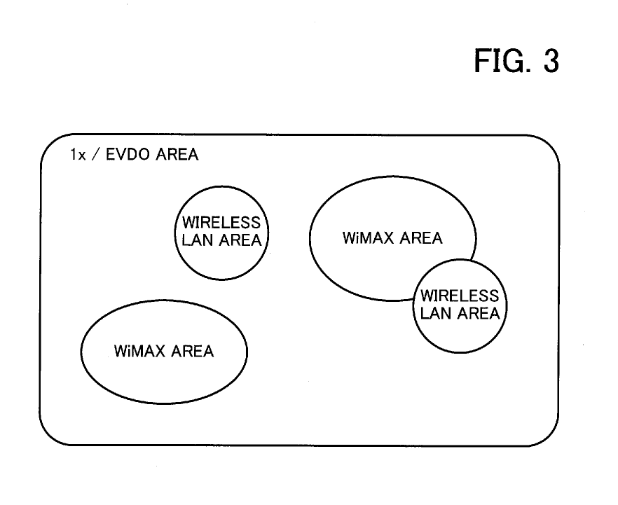

FIG. 3 illustrates an example of an area of a wireless access network. In the second embodiment, the area of the wireless access networks 230 and 240 (WiMAX and wireless LAN) is smaller than the area of the wireless access networks 210 and 220 (1× and EVDO) and overlaps at least part of the area of the wireless access networks 210 and 220. For example, the areas of the wireless access networks 230 and 240 are interspersed within the area of the wireless access networks 210 and 220. The area of the wireless access network 230 and the area of the wireless access network 240 do not agree, however, may sometimes overlap partially.

Because the area of the wireless access networks 230 and 240 is comparatively small, there is a possibility that the mobile station 100 is out of the range of the wireless access networks 230 and 240. However, when the wireless access networks 230 and 240 are utilized, it is possible to perform data communication at higher speed and in wider bandwidth than when the wireless access network 220 is utilized. Consequently, when the mobile station 100 is in the range of the wireless access networks 230 and 240, it is preferable to perform data communication by preferentially utilizing the wireless access networks 230 and 240.

It is to be noted that, it may also be possible to set which is utilized preferentially by the mobile station 100 when both of the wireless access networks 230 and 240 are available. For example, it may also be possible to set so that the mobile station 100 preferentially utilizes the wireless access network 240 (wireless LAN) and utilizes the wireless access network 230 (WiMAX) when the wireless access network 240 is not available.

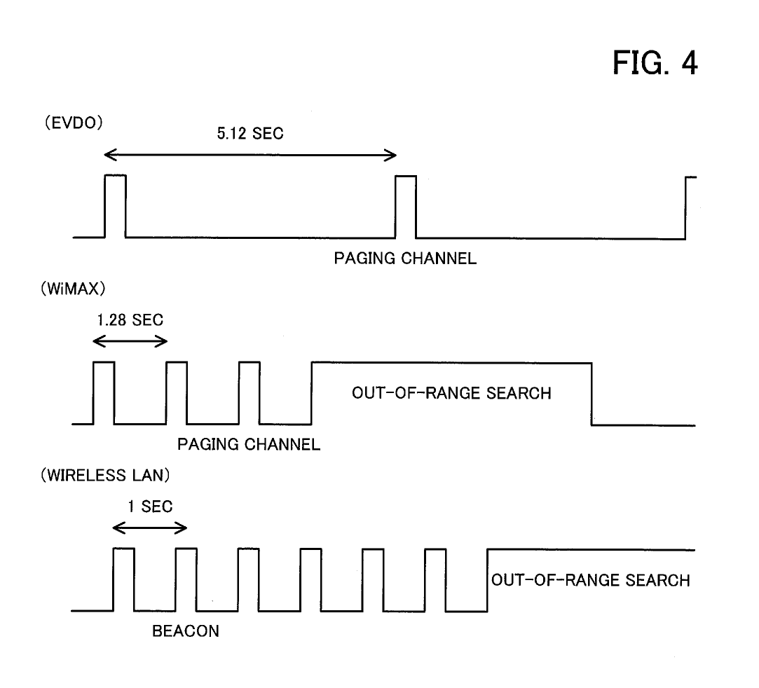

FIG. 4 illustrates an example of a reception timing of paging. From the wireless access networks 220 and 230, a paging channel is transmitted periodically and from the wireless access network 240, a frame called a beacon is transmitted periodically. In the paging channel and beacon, paging information addressed to the mobile station 100 is sometimes included.

The mobile station 100 receives a paging channel intermittently from the base station 211 during standby in the EVDO idle mode after establishing PPP connection with the wireless access network 220. For example, the mobile station 100 receives a paging channel of the wireless access network 220 every 5.12 sec. At this time, the data communication path is set in the wireless access network 220 and the paging information addressed to the mobile station 100 is not transmitted from the wireless access networks 230 and 240. Consequently, it is not necessary for the mobile station 100 to receive the paging channel of the wireless access network 230 or the beacon of the wireless access network 240.

Further, the mobile station 100 receives the paging channel intermittently from the base station 231 during standby in the WiMAX idle mode after connecting to the wireless access network 230. For example, the mobile station 100 receives the paging channel of the wireless access network 230 every 1.28 sec. At this time, the data communication path is set in the wireless access network 230 and the paging information addressed to the mobile station 100 is not transmitted from the wireless access networks 220 and 240. Consequently, it is not necessary for the mobile station 100 to receive the paging channel of the wireless access network 220 or the beacon of the wireless access network 240.

Further, the mobile station 100 receives a frame called a beacon intermittently from the base station 241 during standby in the wireless LAN idle mode after connecting to the wireless access network 240. For example, the mobile station 100 receives the beacon every second. At this time, the data communication path is set in the wireless access network 240 and the paging information addressed to the mobile station 100 is not transmitted from the wireless access networks 220 and 230. Consequently, it is not necessary for the mobile station 100 to receive the paging channel of the wireless access networks 220 and 230.

When failing to receive the WiMAX paging channel during standby, the mobile station 100 makes a search (out-of-range search) for a new accessible base station for a predetermined period of time (for example, for five seconds). When it is not possible to detect a new base station within a predetermined period of time, the mobile station 100 determines that the mobile station 100 has moved out of the range of the wireless access network 230. Similarly, when failing to receive the beacon of the wireless LAN during standby, the mobile station 100 makes an out-of-range search and if it is not possible to detect a new base station within a predetermined period of time, the mobile station 100 determines that the mobile station 100 has moved out of the range of the wireless access network 240.

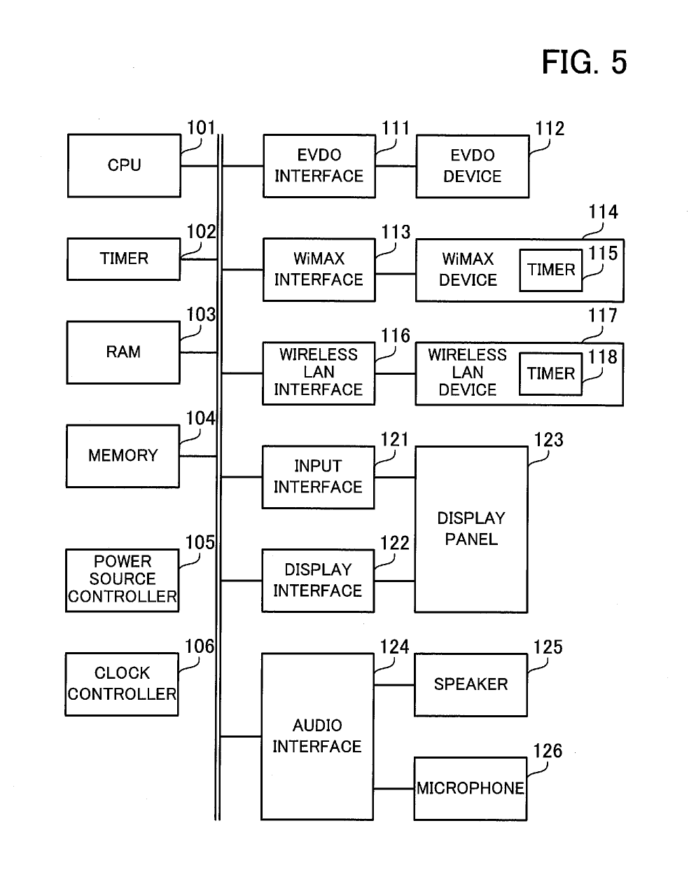

FIG. 5 is a block diagram illustrating a hardware example of a mobile station. The mobile station 100 has a CPU 101, a timer 102, a RAM 103, a memory 104, a power source controller 105, a clock controller 106, an EVDO interface 111, an EVDO device 112, a WiMAX interface 113, a WiMAX device 114, a wireless LAN interface 116, a wireless device 117, an input interface 121, a display interface 122, a display panel 123, an audio interface 124, a speaker 125, and a microphone 126. The WiMAX device 114 has a timer 115. The wireless LAN device 117 has a timer 118.

The CPU 101 is a processor configured to control the connection with the wireless access networks 210, 220, 230, and 240 and to control the user interface including audio input and output and a screen output. The CPU 101 executes programs, such as application programs and driver programs. The CPU 101 reads programs and data from the memory 104 and develops the programs in the RAM 103 to execute. However, it may also be possible for the mobile station 100 to use another kind of processor, such as a DSP, in place of the CPU 101 or together with the CPU 101.

Here, the CPU 101 makes transition to the suspend state of low power consumption if any of events as enumerated below does not occur for a predetermined period of time in the active state and returns to the active state when an interrupt signal is input in the suspend state. In the active state, application programs and driver programs are executed and in the suspend state the application programs or driver programs are not executed and the CPU 101 is in no operation.

Events include (1) touch operation of a user to the display panel 123, (2) update of the screen to be displayed on the display panel 123, (3) execution of application programs, (4) audio communication by utilizing the wireless access network 210, and (5) packet communication by utilizing the wireless access networks 220, 230, and 240. An interrupt signal is input to the CPU 101 via a GPIO (General Purpose Input Output) signal line.

The timer 102 is a hardware timer utilized by the CPU 101. The timer 102 transmits an interrupt signal to the CPU 101 when a set time elapses.

The RAM 103 is a volatile memory configured to temporarily store programs and data used by the CPU 101. It is possible to access a specific storage region of the RAM 103 from the WiMAX device 114 and the wireless LAN device 117. To the specific storage region, an out-of-range flag is written, as will be described later. Note that, it may also be possible for the mobile station 100 to use another kind of memory in place of the RAM 103 or together with the RAM 103.

The memory 104 is a nonvolatile memory configured to store programs and data used by the CPU 101 and for example, is a flash memory. However, it may also be possible for the mobile station 100 to use another kind of nonvolatile storage device in place of the memory 104 or together with the memory 104.

The power source controller 105 controls the power supply to each unit included by the mobile station 100. For example, the power source controller 105 suppresses power to be supplied to the CPU 101 while in the suspend state. Further, for example, the power source controller 105 adjusts power to be supplied to the WiMAX device 114 and the wireless LAN device 117 in accordance with the utilization circumstances of the wireless access networks 230 and 240.

The clock controller 106 controls the supply of a clock signal to each unit included by the mobile station 100. For example, the clock controller 106 reduces the frequency of a clock signal to be supplied to the CPU 101 while in the suspend state. Further, for example, the clock controller 106 adjusts the frequency of a clock signal to be supplied to the WiMAX device 114 and the wireless LAN device 117 in accordance with the utilization circumstances of the wireless access networks 230 and 240.

The EVDO interface 111 is an interface configured to connect the EVDO device 112 to the CPU 101 and the RAM 103.

The EVDO device 112 is a wireless device configured to perform wireless communication by the EVDO scheme by utilizing the wireless access network 220. The EVDO device 112 includes a wireless receiver configured to down-convert a wireless signal received by an antenna into a base band signal and a base band receiver configured to extract data by demodulating and decoding a base band signal. Further, the EVDO device 112 includes a base band transmitter configured to encode and modulate data to be transmitted and a wireless transmitter configured to up-convert a base band signal into a wireless signal. The EVDO device 112 receives a paging channel intermittently while in the EVDO idle mode.

The WiMAX interface 113 is an interface configured to connect the WiMAX device 114 to the CPU 101 and the RAM 103.

The WiMAX device 114 is a wireless device configured to perform wireless communication by the WiMAX scheme by utilizing the wireless access network 230. The WiMAX device 114 includes a wireless receiver, a base band receiver, a base band transmitter, and a wireless transmitter, as similar to the EVDO device 112. The WiMAX device 114 receives a paging channel intermittently while in the WiMAX idle mode. Further, the WiMAX device 114 writes an out-of-range flag indicating whether being in the range or out of the range of the wireless access network 230 to the RAM 103, as will be described later.

The timer 115 is a hardware timer utilized by the WiMAX device 114. For example, when the WiMAX device 114 searches for a base station periodically, the timer 115 is used to determine a timing to make a search. To the time 115, a time is set in accordance with an instruction from the CPU 101 and when a set time elapses, the timer 115 outputs an interrupt signal to cause the WiMAX device 114 to perform a predetermined operation.

The wireless LAN interface 116 is an interface configured to connect the wireless LAN device 117 to the CPU 101 and the RAM 103.

The wireless LAN device 117 is a wireless device configured to perform wireless communication by the wireless LAN scheme by utilizing the wireless access network 240. The wireless LAN device 117 includes a wireless receiver, a base band receiver, a base band transmitter, and a wireless transmitter, as similar to the EVDO device 112. The wireless LAN device 117 receives a beacon intermittently while in the wireless LAN idle mode. Further, the wireless LAN device 117 writes an out-of-range flag indicating whether being in the range or out of the range of the wireless access network 240 to the RAM 103, as will be described later.

The timer 118 is a hardware timer utilized by the wireless LAN device 117. For example, when the wireless LAN device 117 searches for a base station periodically, the timer 118 is used to determine a timing to make a search. To the timer 118, a time is set in accordance with an instruction from the CPU 101 and when a set time elapses, the timer 118 outputs an interrupt signal to cause the wireless LAN device 117 to perform a predetermined operation.

The input interface 121 is an input interface configured to detect a touch operation to the display panel 123 and to notify the CPU 101 of an input signal indicating the touched position.

The display interface 122 is an output interface configured to display a screen generated by the CPU 101 on the display panel 123.

The display panel 123 is a touch panel-attached display. As the display, it is possible to use a liquid crystal display (LCD) and an organic EL (Electro Luminescence) display. To detect a touched position, it is possible to use various kinds of detection system, such as the matrix switch system, resistant film system, surface elastic wave system, infrared system, electromagnetic induction system, and electrostatic capacitance system. A user performs the touch operation by a pointing device, such as a touch pen, or the user's finger. It is to be noted that, it may also be possible for the mobile station 100 to have a key pad including keys, such as character keys and function keys, as an input device.

The audio interface 124 is an interface configured to process an audio signal.

The speaker 125 converts an electric signal as an audio signal acquired from the audio interface 124 into physical vibrations to reproduce a sound. For example, when a user is making a call by utilizing the wireless access network 210, the voice of the other party and the background noises are reproduced from the speaker 125.

The microphone 126 is an interface configured to receive a voice by converting the physical vibrations of a sound into an electric signal and to output an electric signal as an audio signal to the audio interface 124. For example, when a user is making a call by utilizing the wireless access network 210, the voice of the user and background noises on the mobile station 100 side are input from the microphone 126.

Note that, the CPU 101 is an example of the processor 13 of the first embodiment. The RAM 103 is an example of the storage unit 11 of the first embodiment. The WiMAX device 114 and the wireless LAN device 117 are an example of the wireless device 12 of the first embodiment.

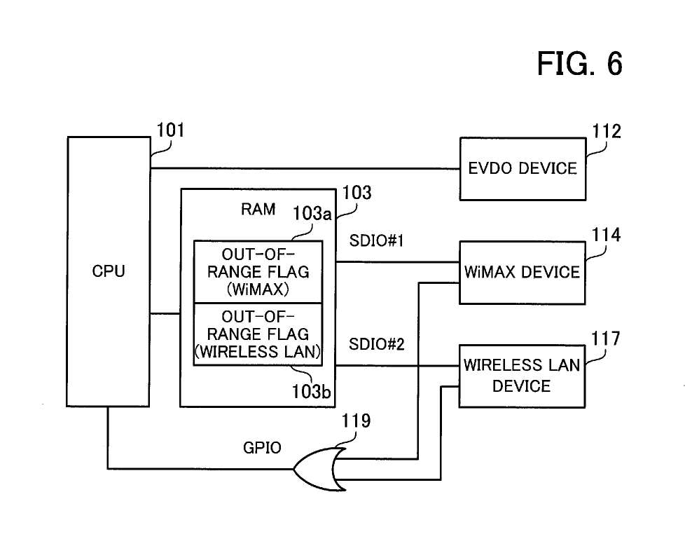

FIG. 6 is a block diagram illustrating an interface of the second embodiment. The WiMAX device 114 and the wireless LAN device 117 are connected to the GPIO and SDIO (Secure Digital Input Output) signal lines, respectively. GPIO is used for transmission of an interrupt signal and SDIO is used for transmission of data.

It is possible for the WiMAX device 114 to access the RAM 103 via an SDIO signal line (SDIO #1). To the RAM 103, an out-of-range flag 103a indicating whether being in the range or out of the range of the wireless access network 230 is written. When detecting the movement from being in the range of the wireless access network 230 to being out of the range and the movement from being out of the range to being in the range, the WiMAX device 114 updates the out-of-range flag 103a and at the same time, outputs an interrupt signal via the GPIO signal line.

It is possible for the wireless LAN device 117 to access the RAM 103 via an SDIO signal line (SDIO #2). To the RAM 103, an out-of-range flag 103b indicating whether being in the range or out of the range of the wireless access network 240 is written. When detecting the movement from being in the range of the wireless access network 240 to being out of the range and the movement from being out of the range to being in the range, the wireless LAN device 117 updates the out-of-range flag 103b and at the same time, outputs an interrupt signal via the GPIO signal line.

An OR circuit 119 is provided between the CPU 101 and the WiMAX device 114 and between the CPU 101 and the wireless LAN device 117. The OR circuit 119 may be provided in one of the WiMAX interface 113 and the wireless LAN interface 116. When at least one of the WiMAX device 114 and the wireless LAN device 117 outputs an interrupt signal, the OR circuit 119 outputs an interrupt signal to the CPU 101 via the GPIO signal line.

Note that, the out-of-range flags 103a and 103b are an example of the flag information 11 a of the first embodiment. Moreover, in the second embodiment, the out-of-range flags 103a and 103b are written to the RAM 103; however, the out-of-range flags 103a and 103b may be written to another storage device included by the mobile station 100.

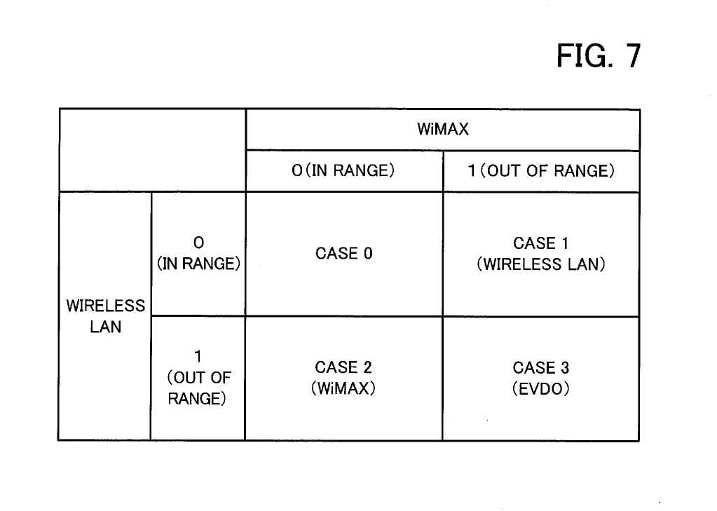

FIG. 7 illustrates combinations of the out-of-range flags. It is possible to represent the out-of-range flags 103a and 103b stored in the RAM 103 by one bit, respectively.

For example, the out-of-range flag 103a=0 indicates being in the range of the wireless access network 230 (WiMAX) and the out-of-range flag 103a=1 indicates being out of the range of the wireless access network 230. The out-of-range flag 103b=0 indicates being in the range of the wireless access network 240 (wireless LAN) and the out-of-range flag 103b=1 indicates being out of the range of the wireless access network 240.

From the combinations of the out-of-range flags 103a and 103b, it is possible to conceive four cases (cases 0 to 3). In the case where the out-of-range flag 103a=the out-of-range flag 103b=0 (case 0), any one of the wireless access networks 230 and 240 may be used for data communication. In the case where the out-of-range flag 103a=1 and the out-of-range flag 103b=0 (case 1), the wireless access network 240 is used for data communication. In the case where the out-of-range flag 103a=0 and the out-of-range flag 103b=1 (case 2), the wireless access network 230 is used for data communication. In the case where the out-of-range flag 103a=the out-of-range flag 103b=1 (case 3), the wireless access network 220 is used for data communication.

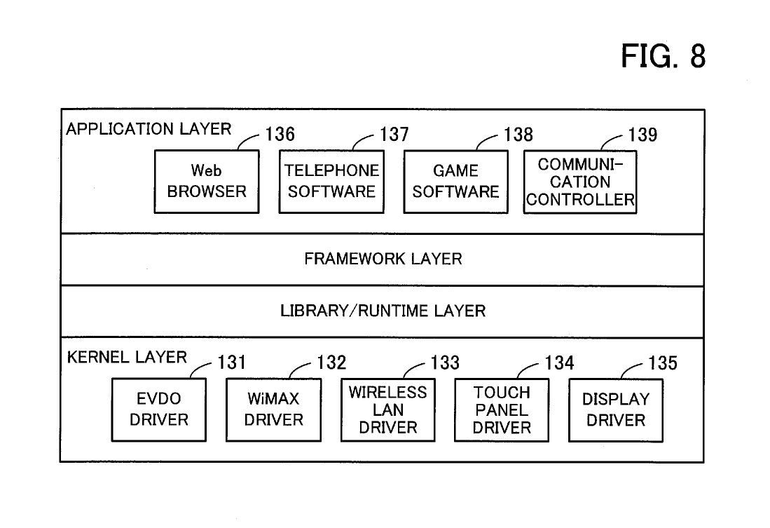

FIG. 8 is a block diagram illustrating a software example configured to control a mobile station. The software executed by the CPU 101 has a hierarchical structure and includes a kernel layer, a library/runtime layer, a framework layer, and an application layer.

The kernel layer provides fundamental functions of an operating system (OS) to control hardware. The library/runtime layer is located in the upper layer of the kernel layer and provides a program execution environment of a virtual machine etc. and a native library implemented with hardware-dependent functions, such as drawing and communication. The framework layer is located in the upper layer of the library/runtime layer and provides a hardware-independent application framework that utilizes the native library. The application layer is located in the upper layer of the framework layer and provides application software utilized by a user.

The kernel layer includes, as software modules, an EVDO driver 131, a WiMAX driver 132, a wireless LAN driver 133, a touch panel driver 134, and a display driver 135. The EVDO driver 131 controls the EVDO device 112. The WiMAX driver 132 controls the WiMAX device 114. The wireless LAN driver 133 controls the wireless LAN device 117. The touch panel driver 134 and the display driver 135 control the display panel 123.

The application layer includes, as software modules, a Web browser 136, telephone software 137, game software 138, and a communication controller 139. The Web browser 136 performs HTTP (Hypertext Transfer Protocol) communication and renders a Web page. The telephone software 137 provides functions for a user to start and end audio communication. The game software 138 is downloaded from the wireless access networks 220, 230, and 240 and provides a user with game functions. The communication controller 139 controls the connection of the wireless access networks 220, 230, and 240 in cooperation with the EVDO driver 131, the WiMAX driver 132, and the wireless LAN driver 133.

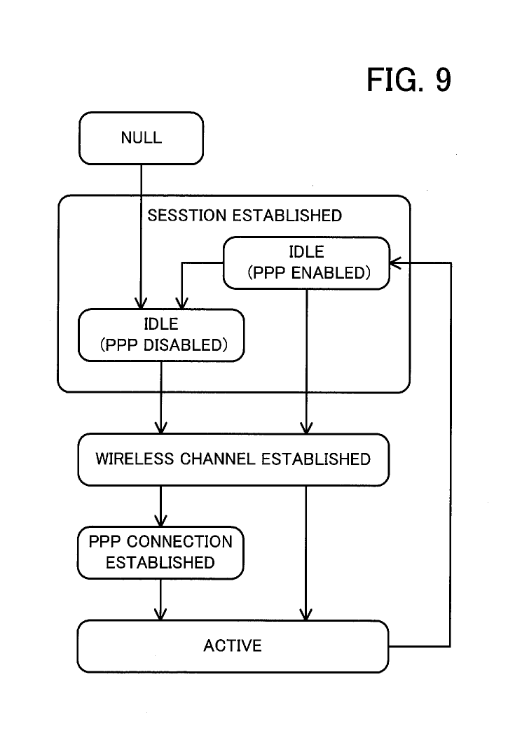

FIG. 9 illustrates a transition example of a data communication state. FIG. 9 illustrates a data communication state between the mobile station 100 and the wireless access network 220 (EVDO).

A state “NULL” is a state where the mobile station 100 is in no operation of signal processing about the wireless access network 220, corresponding to the state where the power source of the mobile station 100 is OFF. When the power source of the mobile station 100 is turned ON, the mobile station 100 transmits and receives messages in the wireless section to and from the base station 211, and thereby, the state “NULL” transitions to a state “IDLE (PPP DISABLED)”.

The state “IDLE (PPP DISABLED)” is a state where the PPP connection with the wireless access network 220 is not established by the mobile station 100. When performing data communication, by the mobile station 100 establishing a traffic channel (TCH), which is a wireless channel, with the base station 211, the state “IDLE (PPP DISABLED)” transitions to a state “WIRELESS CHANNEL ESTABLISHED”. When the mobile station 100 establishes the PPP connection with the PDSN 222 via the base station 211, the state “WIRELESS CHANNEL ESTABLISHED” transitions to a state “PPP CONNECTION ESTABLISHED”.

The state “PPP CONNECTION ESTABLISHED” is a state where the mobile station 100 has established the PPP connection with the wireless access network 220. When the mobile station 100 starts packet format data communication on the PPP connection, the state “PPP CONNECTION ESTABLISHED” transitions to a state “ACTIVE”. The state “ACTIVE” is a state where the mobile station 100 is performing data communication by utilizing the wireless access network 220. When the data communication of the mobile station 100 is completed, the state “ACTIVE” transitions to a state “IDLE (PPP ENABLED)”.

The state “IDLE (PPP ENABLED)” is a state where the PPP connection is maintained. When performing data communication again in response to a request from the mobile station 100 or the IP core network 320, by the mobile station 100 establishing a traffic channel, the state “IDLE (PPP ENABLED)” transitions to the state “WIRELESS CHANNEL ESTABLISHED”. At this time, because the PPP connection is already enabled, the mobile station 100 immediately starts data communication and the state “WIRELESS CHANNEL ESTABLISHED” transitions to the state “ACTIVE”. However, when the mobile station 100 connects to the wireless access networks 230 and 240, the PPP connection with the wireless access network 220 is disabled and the state “IDLE (PPP ENABLED)” transitions to the state “IDLE (PPP DISABLED)” as a result.

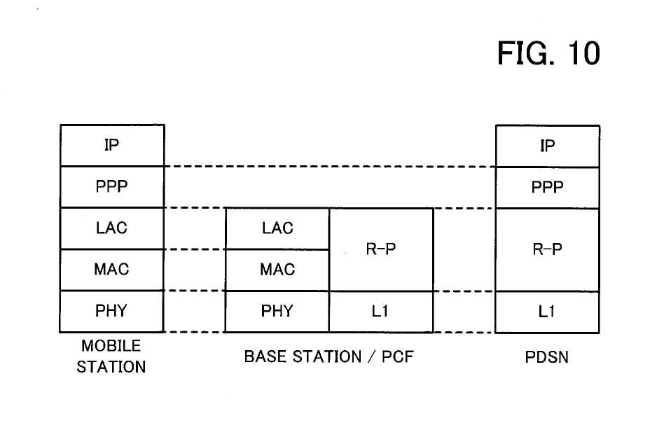

FIG. 10 illustrates a hierarchy example of a data communication protocol. FIG. 10 illustrates a hierarchy of a data communication protocol between the mobile station 100 and the wireless access network 220 (EVDO).

The mobile station 100 communicates with the base station 211 or the PCF 221 using the MAC (Medium Access Control) protocol and the LAC (Link Access Control) protocol on the physical layer. The base station 211 or the PCF 221 communicates with the PDSN 222 using the R-P (Radio Access Network—Packet Data Serving Node) protocol on the physical layer. The mobile station 100 and the PDSN 222 establish the PPP connection on the LAC and R-P by passing through the base station 211 and the PCF 221. In addition, the mobile station 100 and the PDSN 222 transmit and receive IP packets on the PPP connection.

As described previously, it is preferable for the mobile station 100 to perform data communication by utilizing the wireless access network 230 (WiMAX) or the wireless access network 240 (wireless LAN) when being in at least one of the ranges of the wireless access networks 230 and 240. However, when being out of the ranges of the wireless access networks 230 and 240, the mobile station 100 establishes the PPP connection and performs data communication by utilizing the wireless access network 220 (EVDO) as a result. In the following, the connection control of the wireless access networks 220, 230, and 240 as described above is explained.

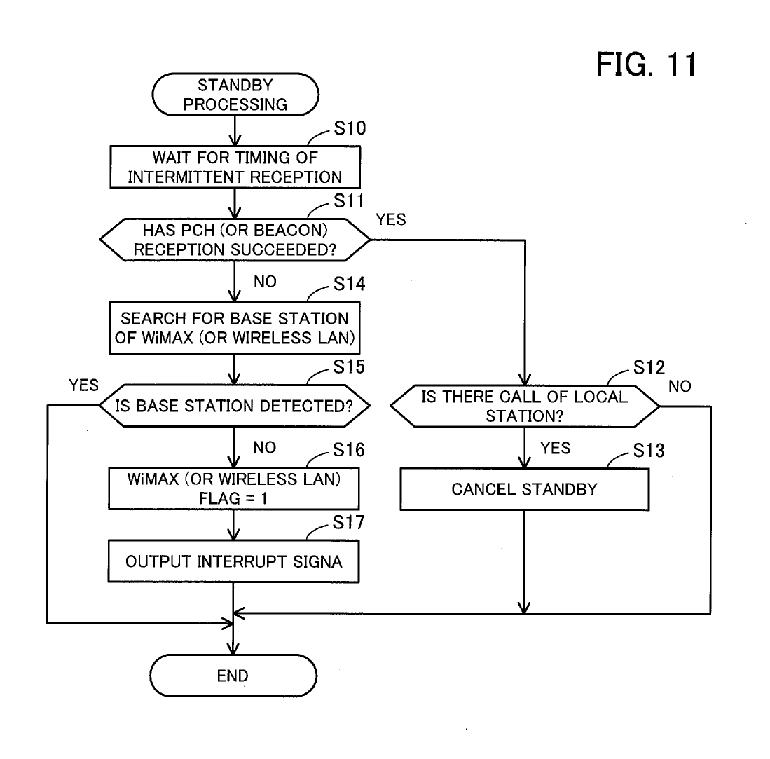

FIG. 11 is a flowchart illustrating standby processing by a wireless device. During standby in the WiMAX idle mode, the standby processing illustrated in FIG. 11 is performed by the WiMAX device 114. During standby in the wireless LAN idle mode, standby processing similar to that of FIG. 11 is performed by the wireless LAN device 117.

(Step S10) The WiMAX device 114 waits for a timing (for example, a period of 1.28 sec) to receive a paging channel next.

(Step S11) The WiMAX device 114 makes an attempt to receive a paging channel from the base station 231 and determines whether the reception of the paging channel has succeeded. When the reception has succeeded, the processing is caused to proceed to step S12 and when the reception has failed, the processing is caused to proceed to step S14. Note that, in the wireless LAN idle mode, the wireless LAN device 117 makes an attempt to receive a beacon from the base station 241 and determines whether the reception of the beacon has succeeded.

(Step S12) The WiMAX device 114 determines whether paging information indicative of a call of the local station is included in the received paging channel. When included, the processing is caused to proceed to step S13 and when not, the processing is exited.

(Step S13) The WiMAX device 114 cancels the WiMAX idle mode and starts to receive data from the base station 231. Then, the standby processing is exited.

(Step S14) The WiMAX device 114 makes a search (out-of-range search) for a base station of the wireless access network 230. A base station is detected, for example, by capturing a pilot signal transmitted by the base station. It is to be noted that, in the case of the wireless LAN idle mode, the wireless LAN device 117 makes a search (out-of-range search) for a base station of the wireless access network 240.

(Step S15) The WiMAX device 114 determines whether an accessible base station (for example, a base station the received power level from which exceeds a threshold value) is detected by the out-of-range search. When detected, the processing is exited and when not detected, the processing is caused to proceed to step S16.

(Step S16) The WiMAX device 114 accesses the RAM 103 via the SDIO signal line and writes the out-of-range flag 103a=1 to the RAM 103. Note that, in the case of the wireless LAN idle mode, the wireless LAN device 117 accesses the RAM 103 via the SDIO signal line and writes the out-of-range flag 103b=1 to the RAM 103.

(Step S17) The WiMAX device 114 transmits an interrupt signal to the CPU 101 via the GPIO signal line. When the CPU 101 is in the suspend state, it is expected that the CPU 101 returns to the active state by the interrupt signal.

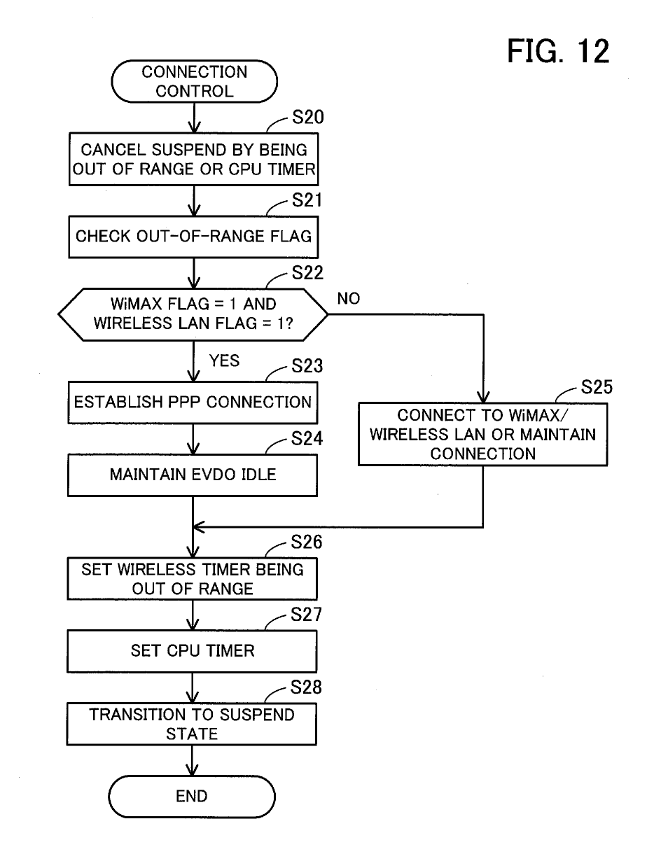

FIG. 12 is a flowchart illustrating the connection control of the second embodiment. During standby in one of the EVDO, WiMAX, and wireless LAN idle modes, the connection control illustrated in FIG. 12 is performed by the CPU 101. It is to be noted that, processing in the following steps S21 to S27 is controlled by the communication controller 139 of the application layer.

(Step S20) When an interrupt signal is input, the CPU 101 cancels the suspend state and returns to the active state. An interrupt signal that may be input includes an interrupt signal from the WiMAX device 114 or the wireless LAN device 117 and an interrupt signal from the timer 102 set by the CPU 101.

(Step S21) When the suspend state is cancelled, the CPU 101 accesses the RAM 103 and checks the out-of-range flags 103a and 103b.

(Step S22) The CPU 101 determines whether the out-of-range flag 103a=1 and the out-of-range flag 103b=1 (case 3). When the conditions are met, the processing is caused to proceed to step S23 and when the conditions are not met, the processing is caused to proceed to step S25.

(Step S23) The CPU 101 instructs the EVDO device 112 to establish connection. The EVDO device 112 establishes PPP connection with the wireless access network 220.

(Step S24) The EVDO device 112 maintains the EVDO idle mode.

(Step S25) The CPU 101 connects to one of the wireless access networks 230 and 240, of which being in the range, or controls to maintain the connection when already connected thereto. In the case where the out-of-range flag 103a=1 and the out-of-range flag 103b=0 (case 1), the wireless access network 240 is selected and in the case where the out-of-range flag 103a=0 and the out-of-range flag 103b=1 (case 2), the wireless access network 230 is selected as a result.

(Step S26) For a base station search, the CPU 101 sets the timer 115 when the out-of-range flag 103a=1 (when out of the range of the wireless access network 230) and sets the timer 118 when the out-of-range flag 103b=1 (when out of the range of the wireless access network 240).

(Step S27) The CPU 101 sets the timer 102. Due to this, even if the CPU 101 fails to receive an interrupt signal from the WiMAX device 114 and the wireless LAN device 117, it is possible to check the out-of-range flags 103a and 103b periodically and to determine whether to establish PPP connection of the wireless access network 220.

(Step S28) The CPU 101 makes transition from the active state to the suspend state.

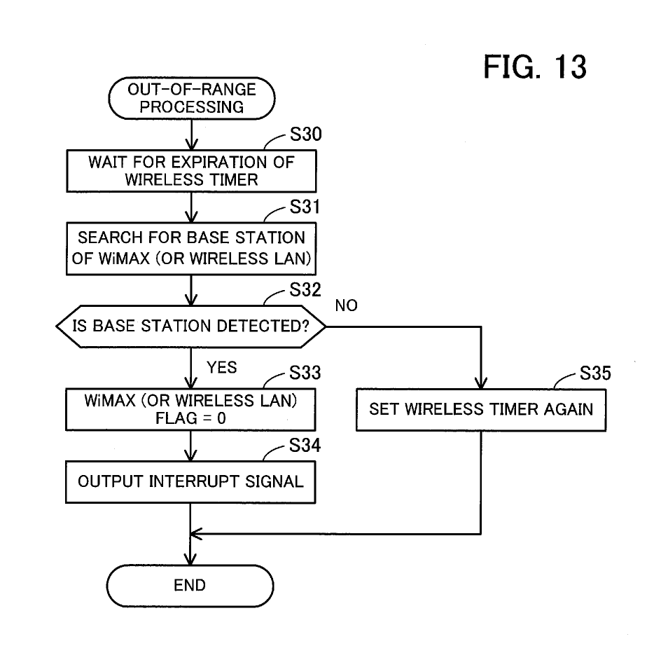

FIG. 13 is a flowchart illustrating out-of-range processing by a wireless device. When the mobile station 100 is out of the range of the wireless access network 230, the out-of-range processing illustrated in FIG. 13 is performed by the WiMAX device 114. When the mobile station 100 is out of the range of the wireless access network 240, out-of-range processing similar to that of FIG. 13 is performed by the wireless LAN device 117.

(Step S30) The WiMAX device 114 waits for a timing at which the timer 115 expires (timing to search for a base station next).

(Step S31) The WiMAX device 114 searches for a base station of the wireless access network 230. A base station is detected, for example, by capturing a pilot signal transmitted by the base station. Note that, when the mobile station 100 is out of the range of the wireless access network 240, the wireless LAN device 117 searches for a base station of the wireless access network 240.

(Step S32) The WiMAX device 114 determines whether an accessible base station (for example, a base station the received power level from which exceeds a threshold value) is detected by the search. When detected, the processing is caused to proceed to step S33 and when not detected, the processing is caused to proceed to step S35.

(Step S33) The WiMAX device 114 accesses the RAM 103 via the SDIO signal line and writes the out-of-range flag 103a=0 to the RAM 103. It is to be noted that, in the case of the wireless access network 240, the wireless LAN device 117 accesses the RAM 103 via the SDIO signal line and writes the out-of-range flag 103b=0 to the RAM 103.

(Step S34) The WiMAX device 114 transmits an interrupt signal to the CPU 101 via the GPIO signal line. When the CPU 101 is in the suspend state, it is expected that the CPU 101 returns to the active state by the interrupt signal.

(Step S35) The WiMAX device 114 sets the timer 115 again to wait for a timing to search for a base station next. Note that, when the mobile station 100 is out of the range of the wireless access network 240, the wireless LAN device 117 sets the timer 118 again.

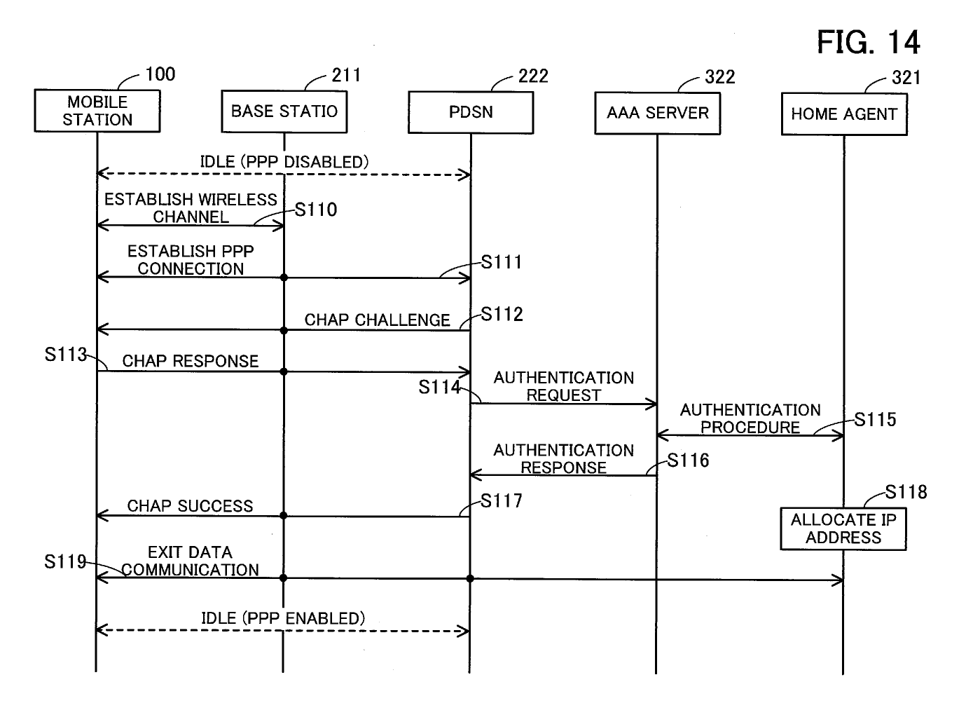

FIG. 14 is a sequence diagram illustrating an example of connection to a wireless access network. FIG. 14 illustrate an example of a procedure for the mobile station 100 to make transition from the state “IDLE (PPP DISABLED)” to the state “IDLE (PPP ENABLED)” by establishing PPP connection. The sequence illustrated in FIG. 14 is performed, for example, in step S23 described previously.

The mobile station 100 communicates with the base station 211 and establishes a traffic channel, which is a wireless channel (step S110). The mobile station 100 accesses the base station 211 on the traffic channel and establishes PPP connection with the PDSN 222 via the base station 211 and the PCF 221 (step S111).

The PDSN 222 transmits a CHAP (Challenge Handshake Authentication Protocol) challenge message including a generated random number in order to authenticate the mobile station 100 (step S112). The mobile station 100 applies a predetermined one-directional function (for example, hash function) to the random number and transmits a CHAP response message including the calculation result to the PDSN 222. When the calculation result of the mobile station 100 agrees with an “expected calculation result” calculated on the network side by applying the generated random number to the predetermined one-directional function, the mobile station 100 is authenticated to have the connection right (step S113).

The PDSN 222 requests the AAA server 322 to authenticate the mobile station 100 (step S114). The AAA server 322 transmits and receives an authentication procedure message to and from the home agent 321 and registers the mobile station 100 to the home agent 321 (step S115). The AAA server 322 transmits a response message indicating that authentication has succeeded to the PDSN 222 (step S116). The PDSN 222 transmits a message indicating the success of CHAP authentication to the mobile station 100 (step S117). Further, the home agent 321 allocates an IP address to the mobile station 100 (step S118).

When the mobile station 100 is authenticated and an IP address is allocated to the mobile station 100, the mobile station 100 exits the data communication (step S119). The mobile station 100 maintains the PPP connection established with the PDSN 222 and operates as the EVDO idle mode.

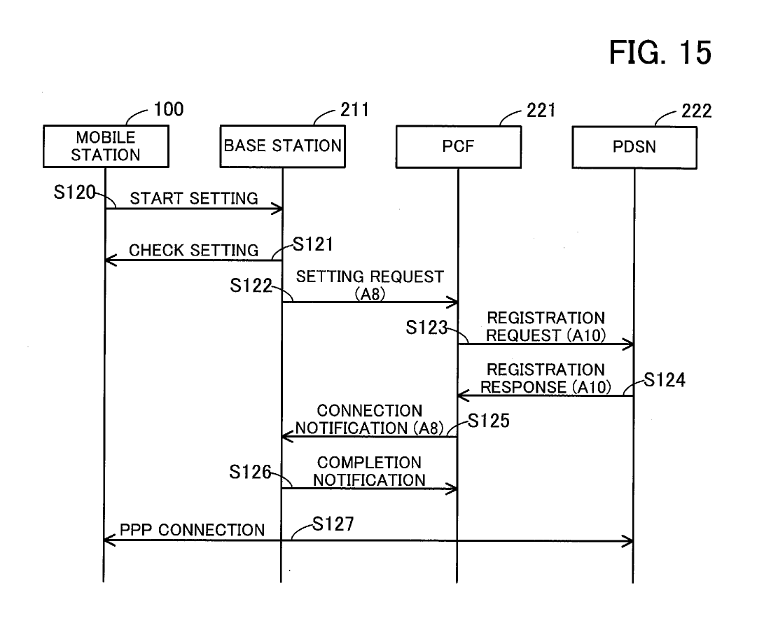

FIG. 15 is a sequence diagram illustrating an example of PPP connection. FIG. 15 illustrates details of PPP connection establishment in step S111. Note that, details of PPP are also described in the RFC (Request for Comment) 1661.

The mobile station 100 requests the base station 211 to start setting of PPP connection on the traffic channel (step S120). The base station 211 transmits an acknowledgment response of setting start to the mobile station 100 (step S121). The base station 211 establishes A8 connection with the PCF 221 and transmits a setting request to the PCF 221 on the A8 connection (step S122). The PCF 221 establishes A10 connection with the PDSN 222 and transmits a registration request to the PDSN 222 on the A10 connection (step S123).

The PDSN 222 transmits a registration response to the PCF 221 (step S124). The PCF 221 transmits a connection notification to the base station 211 (step S125). The base station 211 transmits a completion notification to the PCF 221 (step S126). Due to this, it is made possible for the mobile station 100 to communicate with the PDSN 222 via the base station 211 and the PCF 221. The mobile station 100 sets PPP connection with the PDSN 222 (step S127).

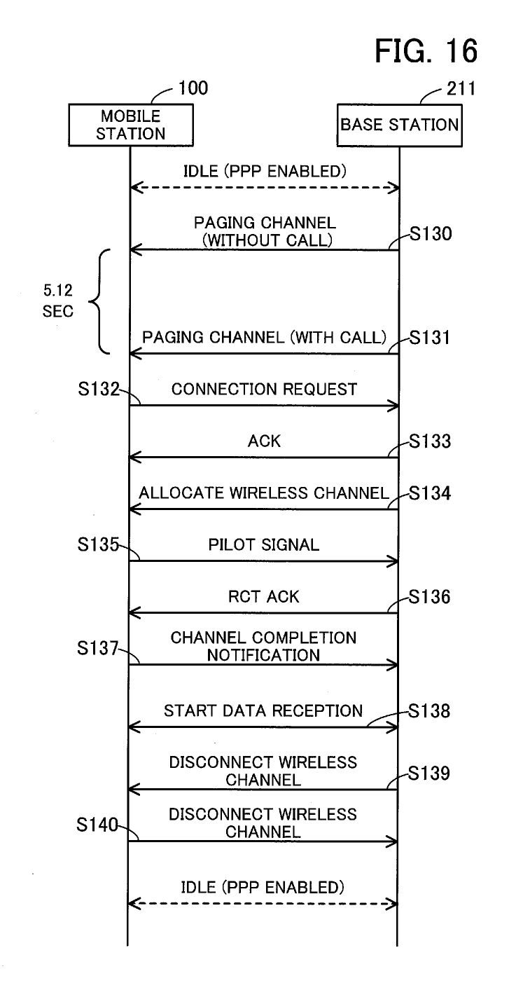

FIG. 16 is a sequence diagram illustrating an example of reception of a paging channel. FIG. 16 illustrates a case where a data communication path is set in the wireless access network 220 (EVDO) by establishing PPP connection and the mobile station 100 receives a paging channel from the wireless access network 220. The sequence of FIG. 16 is performed, for example, after step S24 described previously.

The base station 211 transmits a paging channel periodically. The mobile station 100 receives the paging channel at a predetermined period (for example, a period of 5.12 sec) and determines whether there is a call of the local station. When there is no call of the local station, the mobile station 100 stops processing of the signal of the wireless access network 220 until a timing to receive the paging channel next (step S130).

When detecting a call of the local station (step S131), the mobile station 100 transmits a connection request to the base station 211 (step S132). When detecting the connection request from the mobile station 100, the base station 211 transmits ACK (Acknowledgement) to the mobile station 100 (step S133).

The base station 211 allocates a traffic channel to the mobile station 100 and notifies the channel allocation to the mobile station 100 (step S134). The mobile station 100 transmits a pilot signal about the traffic channel allocated by the base station 211 (step S135). The base station 211 confirms that the communication quality of the allocated traffic channel is not problematic based on the pilot signal received from the mobile station 100 and transmits ACK of RCT (Radio Conformance Test) to the mobile station 100 (step S136). The mobile station 100 notifies the completion of setting of the traffic channel to the base station 211 (step S137).

The mobile station 100 starts to receive data from the base station 211 (step S138). At this time, because the PPP connection is already established, it is possible to start data communication quickly after the establishment of a wireless channel. When completing transmission of data to the mobile station 100, the base station 211 notifies the connection release of the wireless channel to the mobile station 100 (step S139). The mobile station 100 releases the connection of the wireless channel and responds to the base station 211 (step S140). However, the PPP connection is maintained. Due to this, the mobile station 100 makes transition again to the state “IDLE (PPP ENABLED)”.

According to the mobile communication system of the second embodiment, the out-of-range flags 103a and 103b are written to the RAM 103 and preserved therein, and therefore, it is possible for the CPU 101 whose suspend state is cancelled to recognize the wireless state with precision by referring to the RAM 103. Further, after the suspend state is cancelled, it is not necessary for the CPU 101 to inquire the wireless state of the wireless access networks 230 and 240 by transmitting a command to the WiMAX device 114 or the wireless LAN device 117. Consequently, it is possible to quickly confirm the wireless state and to reduce the overhead of connection control. In particular, it is made easy for the CPU 101 to confirm the combination of the wireless states of the wireless access networks 230 and 240 and it is made possible to quickly perform connection control of the wireless access network 220.

Because of this, even when the mobile station 100 moves out of the ranges of both of the wireless access networks 230 and 240 during standby, the PPP connection of the wireless access network 220 is established quickly, and therefore, it is possible to shorten the period of time during which reception of a paging channel about data communication is disabled. Further, it is possible to shorten the period of time during which the CPU 101 is in the active state during standby and to reduce power consumption of the mobile station 100. Furthermore, when moving out of the ranges of the wireless access networks 230 and 240, the mobile station 100 remains on standby while maintaining the PPP connection of the wireless access network 220. Consequently, it is not necessary to perform the procedure to establish the PPP connection after receiving a call from the wireless access network 220 and it is possible to suppress the overhead before data communication is started.

### Third Embodiment

Next, a third embodiment is explained. Differences from the second embodiment are explained mainly and explanation of the same items as those of the second embodiment is omitted. A mobile station of the third embodiment utilizes the wireless access networks 220 and 230 (EVDO and WiMAX) for data communication but does not utilize the wireless access network 240 (wireless LAN) for data communication.

Because of this, it is not necessary for the mobile station of the third embodiment to include the wireless LAN interface 116 and the wireless LAN device 117 of the units of the mobile station 100 illustrated in FIG. 5.

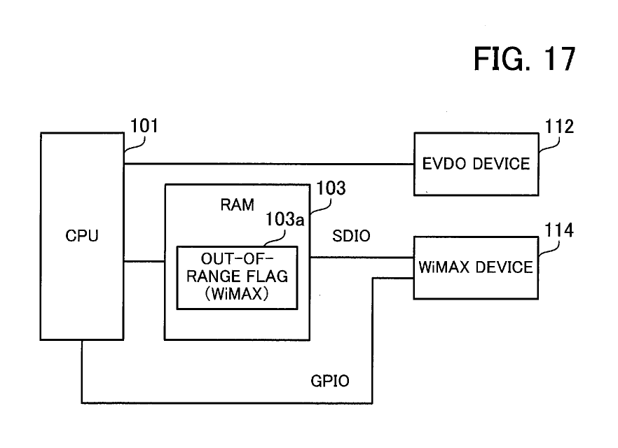

FIG. 17 is a block diagram illustrating an interface of the third embodiment.

As described previously, when detecting the movement from being in the range of the wireless access network 230 to being out of the range and the movement from being out of the range to being in the range, the WiMAX device 114 writes the out-of-range flag 103a about WiMAX to the RAM 103 via the SDIO signal line. However, it is not necessary for the RAM 103 to store the out-of-range flag about the wireless LAN (the out-of-range flag 103b described previously).

Further, as described previously, when detecting the movement from being in the range of the wireless access network 230 to being out of the range and the movement from being out of range to being in the range, the WiMAX device 114 outputs an interrupt signal. The interrupt signal is input to the CPU 101 via the GPIO signal line.

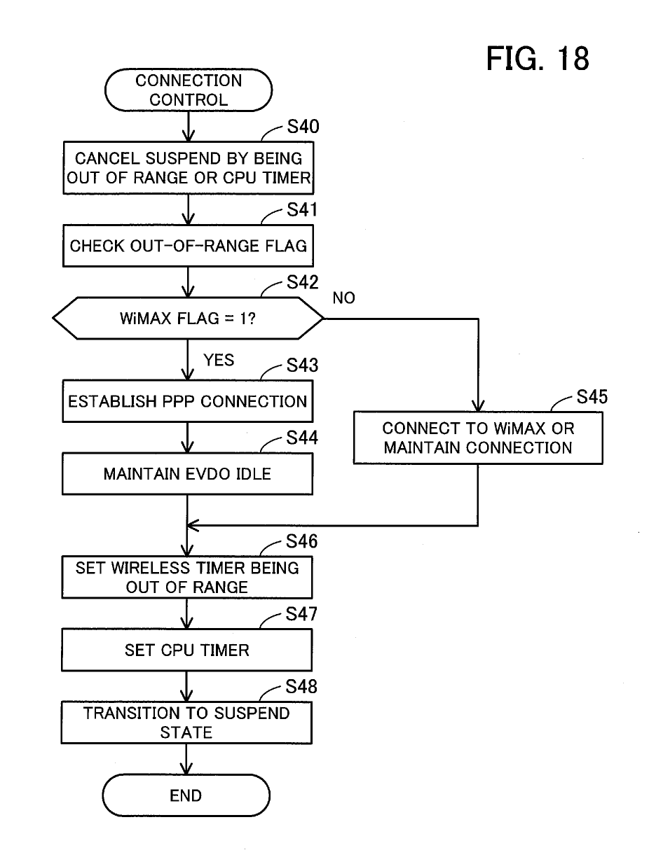

FIG. 18 is a flowchart illustrating connection control of the third embodiment. During standby in the EVDO or WiMAX idle mode, the connection control illustrated in FIG. 18 is performed by the CPU 101. FIG. 18 corresponds to the connection control of the second embodiment illustrated in FIG. 12.

(Step S40) When an interrupt signal is input, the CPU 101 cancels the suspend state and returns to the active state. The interrupt signal that may be input includes an interrupt signal from the WiMAX device 114 and an interrupt signal from the timer 102.

(Step S41) When the suspend state is cancelled, the CPU 101 accesses the RAM 103 and checks the out-of-range flag 103a.

(Step S42) The CPU 101 determines whether the out-of-range flag 103a=1 (whether being out of the range of the wireless access network 230). When the condition is met, the processing is caused to proceed to step S43 and when the condition is not met, the processing is caused to proceed to step S45.

(Step S43) The CPU 101 instructs the EVDO device 112 to establish connection. The EVDO device 112 establishes PPP connection with the wireless access network 220.

(Step S44) The EVDO device 112 maintains the EVDO idle mode.

(Step S45) The CPU 101 connects to the wireless access network 230 or controls to maintain the connection when already connected.

(Step S46) The CPU 101 sets the timer 115 when the out-of-range flag 103a=1 (when out of the range of the wireless access network 230) for a base station search.

(Step S47) The CPU 101 sets the timer 102.

(Step S48) The CPU 101 makes transition from the active state to the suspend state.

According to the mobile communication system of the third embodiment, the out-of-range flag 103a is written to the RAM 103 and preserved therein, and therefore, it is possible for the CPU 101 whose suspend state is cancelled to recognize the wireless state with precision by referring to the RAM 103. Further, it is not necessary for the CPU 101 to inquire the wireless state of the wireless access network 230 by transmitting a command to the WiMAX device 114 after the suspend state is cancelled. Consequently, it is possible to quickly check the wireless state and to reduce the overhead of connection control.

Because of this, as in the second embodiment, the period of time during which it is not possible for the mobile station to receive the paging channel about data communication is shortened. Further, it is possible to shorten the period of time during which the CPU 101 is in the active state and to reduce the power consumption of the mobile station. Furthermore, by maintaining the PPP connection during standby, it is possible for the mobile station to suppress the overhead before starting data communication.

It is possible to make efficient the communication control when there is a plurality of wireless access networks that may be utilized.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A mobile communication device capable of communication by utilizing first and second wireless access networks, comprising:
a storage unit;
a wireless device configured to detect a wireless state of the first wireless access network and to write flag information in accordance with the detected wireless state to the storage unit; and
a processor configured to control connection with the second wireless access network based on the flag information stored in the storage unit when a suspend state is cancelled.

2. The mobile communication device according to claim 1,
wherein the processor determines whether the flag information indicates being out of the range and selects whether or not to establish connection with the second wireless access network in accordance with the determination result.

3. The mobile communication device according to claim 1, further comprising another wireless device configured to detect a wireless state of a third wireless access network and to write another piece of flag information in accordance with the detected wireless state to the storage unit,
wherein the processor controls connection with the second wireless access network based on a combination of the flag information and the other piece of flag information stored in the storage unit.

4. The mobile communication device according to claim 3,
wherein the processor determines whether both the flag information and the other piece of flag information indicate being out of the range and selects whether or not to establish connection with the second wireless access network in accordance with the determination result.

5. The mobile communication device according to claim 1,
wherein when detecting being out of the range of the first wireless access network, the wireless device writes a value indicating being out of the range to the storage unit as the flag information and outputs an interrupt signal, and
the suspend state of the processor is cancelled by the interrupt signal.

6. A wireless communication method performed by a mobile communication device capable of communication by utilizing first and second wireless access networks and comprising a processor and storage unit, the method including:
writing flag information in accordance with a wireless state of the first wireless network to the storage unit;
accessing the flag information stored in the storage unit from the processor when a suspend state of the processor is cancelled; and
controlling connection with the second wireless access network based on the flag information.
